(19) United States
(12) Patent Application Publication
(10) Pub. No.: US 2024/0230345 A1
(43) Pub. Date: Jul. 11, 2024

(54) Bus Route Mobile Application

(71) Applicant: Jeremy Bridwell, Bath, NC (US)

(72) Inventor: Jeremy Bridwell, Bath, NC (US)

(21) Appl. No.: 18/504,267

(22) Filed: Nov. 8, 2023

Related U.S. Application Data
(60) Provisional application No. 63/437,380, filed on Jan. 6, 2023.

(51) Int. Cl. G01C 21/34; G01C 21/36

(52) U.S. Cl. CPC G01C 21/3438; G01C 21/3632

(57) ABSTRACT

A bus route mobile application is provided. The application is comprised of a bus route mobile application that can be used on a smart device within a bus by a bus driver. The application provides a bus driver with a route having each pickup/drop-off address of a child (or other) passenger. The application also allows a plurality of pick-up and drop-off information to be communicated to a bus driver and parents/caregivers of child passengers.

### CROSS-REFERENCE TO RELATED APPLICATION

The present application claims priority to, and the benefit of, U.S. Provisional Application No. 63/437,380, which was filed on Jan. 6, 2023, and is incorporated herein by reference in its entirety.

### FIELD OF THE INVENTION

The present invention relates generally to the field of mobile applications. More specifically, the present invention relates to a bus route mobile application that can be used by a bus driver to effectively travel along a bus route accurately. Accordingly, the present disclosure makes specific reference thereto. Nonetheless, it is to be appreciated that aspects of the present invention are also equally applicable to other like applications, and methods of manufacture.

### BACKGROUND

Individuals who drive buses for school students may have no tools or resources to remember planned routes to pick up and drop off children. This makes it particularly challenging for said individuals to ensure that they are picking up and dropping off students at the correct locations. Substitute bus drivers, who may not be familiar with the route since they do not complete it daily, may be unable to properly follow the route. This can cause delays and can be particularly stressful for the substitute drivers as they try to navigate unfamiliar routes while ensuring the safety of the children onboard.

Furthermore, parents may worry if a child is not picked up and dropped off at the same time each day. Consistent pickup and drop-off times are important for parents to manage their schedules and ensure the safety of their children. Inconsistent pick-up and drop-off times can cause anxiety and inconvenience for parents, as they may need to rearrange their schedules or make alternative arrangements for their children. Additionally, it can also be stressful for the children who may feel anxious or uncertain about when they will be picked up or dropped off.

Therefore, there exists a long-felt need in the art for an invention that improves bus routes. There also exists a long-felt need in the art for a bus route mobile application. More specifically, there exists a long-felt need in the art for a bus route mobile application that displays a bus route that can be easily followed by a bus driver.

The subject matter disclosed and claimed herein, in one embodiment thereof, comprises a bus route mobile application. The application is comprised of a bus route mobile application. The application can be used on a smart device within a bus by a bus driver. The application provides a bus driver with a route having each pickup/drop-off address of a child (or other) passenger. The application also allows a plurality of pick-up and drop-off information to be communicated to a bus driver and parents/caregivers of child passengers.

In this manner, the bus route mobile application of the present invention accomplishes all of the foregoing objectives and provides an invention that improves bus routes via a bus route mobile application. More specifically, the bus route mobile application displays a bus route that can be easily followed by a bus driver and ensures all passengers are picked up and dropped off along the route as they should be.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bus route mobile application. The application is comprised of a mobile application that can be used in order to generate and share bus routes. In the preferred embodiment, the bus route includes a school bus route for pickup and/or dropping off children. The application may be used on any smart device such as, but not limited to, a computer, a tablet, a cell phone, etc., such that it can be seen by the driver (or other bus).

The application has a plurality of features. A first feature allows a bus driver (or other administrative user of the application such as, but not limited to, a parent, a legal guardian, a school administrator, etc.) to input at least one pickup/drop-off address displayed via at least one icon on a geographical map interface on the application. The map will be visible to a bus driver while using the application. The application automatically creates the fastest route based on each address inputted.

At least one profile can be created for each bus passenger (i.e., child), wherein the profile may have information such as, but not limited to, at least one pickup address and at least one drop-off address. The pickup and drop-off addresses can be configured within the profile to switch automatically based on week, day, time, etc. The profile may also have other information that can be accessed by a bus driver using the application. The profile may also allow a user such as, but not limited to, a parent to input notes or instructions that are relayed to the bus driver (or other administrative user) once the pickup or drop-off address of the passenger has been reached.

Once all addresses for a route have been inputted and the bus begins driving, the real-time location and route of the bus can be shared manually or automatically with users of the application such as, but not limited to, parents. This allows parents to track the location of the bus and ensure they are home to send or receive children passengers onto/from the bus. In addition, the application may provide each user with an estimated time of arrival for the bus to the address inputted. This allows a parent or other caregiver to know precisely when the bus will arrive to pick up or drop-off a child passenger.

The present invention is also comprised of a method of using the application. First, an application is provided comprised of a plurality of features including a profile, a map, a messaging feature, an input address feature, and a remove address feature. Then, a user such as, but not limited to, a parent can create a profile for a child passenger, wherein the profile includes information such as, but not limited to, pick-up addresses, drop-off addresses, medical information, contact information, pickup, and drop-off address schedules, etc. Then, a bus driver opens the application on a smart device, such as, but not limited to, a tablet, and begins driving on a pickup and/or drop-off route automatically created by the application. The bus driver observes at least one icon on the map which represents at least one pickup and/or drop-off address for a child passenger. The bus driver and/or the application itself may also manually/automatically share the location of the bus as well as send an ETA for each pickup and/or drop-off point on the route. Once a child has been picked up or dropped off, the bus driver (or the application itself) may manually/automatically send a confirmation notification of the pickup and/or drop-off to contacts associated with the profile of the child passenger who was picked up or dropped off.

Accordingly, the bus route mobile application of the present invention is particularly advantageous as it provides an invention that improves bus routes via a bus route mobile application. More specifically, the bus route mobile application displays a bus route that can be easily followed by a bus driver and ensures all passengers are picked up and dropped off along the route as they should be. In this manner, the bus route mobile application overcomes the limitations of existing methods of driving bus routes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of one potential embodiment of a bus route mobile application of the present invention in accordance with the disclosed architecture; and

FIG. 2 illustrates a flowchart of a method of using one potential embodiment of a bus route mobile application of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof.

It may be evident, however, that the innovation can be practiced without these specific details. In other instances, well-known structures and applications are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention.

Additionally, an illustrated embodiment need not have all the aspects or advantages shown. Thus, in other embodiments, any of the features described herein from different embodiments may be combined.

As noted above, there exists a long-felt need in the art for an invention that improves bus routes. There also exists a long-felt need in the art for a bus route mobile application. More specifically, there exists a long-felt need in the art for a bus route mobile application that displays a bus route that can be easily followed by a bus driver.

The present invention, in one exemplary embodiment, is comprised of a bus route mobile application that can be used in order to generate and share bus routes. In the preferred embodiment, the bus route includes a school bus route for pickup and/or dropping off children.

The application may be used on any smart device such as, but not limited to, a computer, a tablet, a cell phone, etc., such that it can be seen by the driver (or other bus).

The application has a plurality of features. A first feature allows a bus driver (or other administrative user of the application such as, but not limited to, a parent, a legal guardian, a school administrator, etc.) to input at least one pickup/drop-off address displayed via at least one icon on a geographical map interface on the application. The map will be visible to a bus driver while using the application. The application automatically creates the fastest route based on each address inputted.

At least one profile can be created for each bus passenger (i.e., child), wherein the profile may have information such as, but not limited to, at least one pickup address and at least one drop-off address. The pickup and drop-off addresses can be configured within the profile to switch automatically based on week, day, time, etc. The profile may also have other information that can be accessed by a bus driver using the application. The profile may also allow a user such as, but not limited to, a parent to input notes or instructions that are relayed to the bus driver (or other administrative user) once the pickup or drop-off address of the passenger has been reached.

Once all addresses for a route have been inputted and the bus begins driving, the real-time location and route of the bus can be shared manually or automatically to users of the application such as, but not limited to, parents. This allows parents to track the location of the bus and ensure they are home to send or receive children passengers onto/from the bus. In addition, the application may provide each user with an estimated time of arrival for the bus to the address inputted. This allows a parent or other caregiver to know precisely when the bus will arrive to pick up or drop-off a child passenger.

The present invention is also comprised of a method of using the application. First, an application is provided comprised of a plurality of features including a profile, a map, a messaging feature, an input address feature, and a remove address feature. Then, a user such as, but not limited to, a parent can create a profile for a child passenger, wherein the profile includes information such as, but not limited to, pick-up addresses, drop-off addresses, medical information, contact information, pickup, and drop-off address schedules, etc. Then, a bus driver opens the application on a smart device, such as, but not limited to, a tablet, and begins driving on a pickup and/or drop-off route automatically created by the application. The bus driver observes at least one icon on the map which represents at least one pickup and/or drop-off address for a child passenger. The bus driver and/or the application itself may also manually/automatically share the location of the bus as well as send an ETA for each pickup and/or drop-off point on the route. Once a child has been picked up or dropped off, the bus driver (or the application itself) may manually/automatically send a confirmation notification of the pickup and/or drop-off to contacts associated with the profile of the child passenger who was picked up or dropped off.

Accordingly, the bus route mobile application of the present invention is particularly advantageous as it provides an invention that improves bus routes via a bus route mobile application. More specifically, the bus route mobile application displays a bus route that can be easily followed by a bus driver and ensures all passengers are picked up and dropped off along the route as they should be. In this manner, the bus route mobile application overcomes the limitations of existing methods of driving bus routes known in the art.

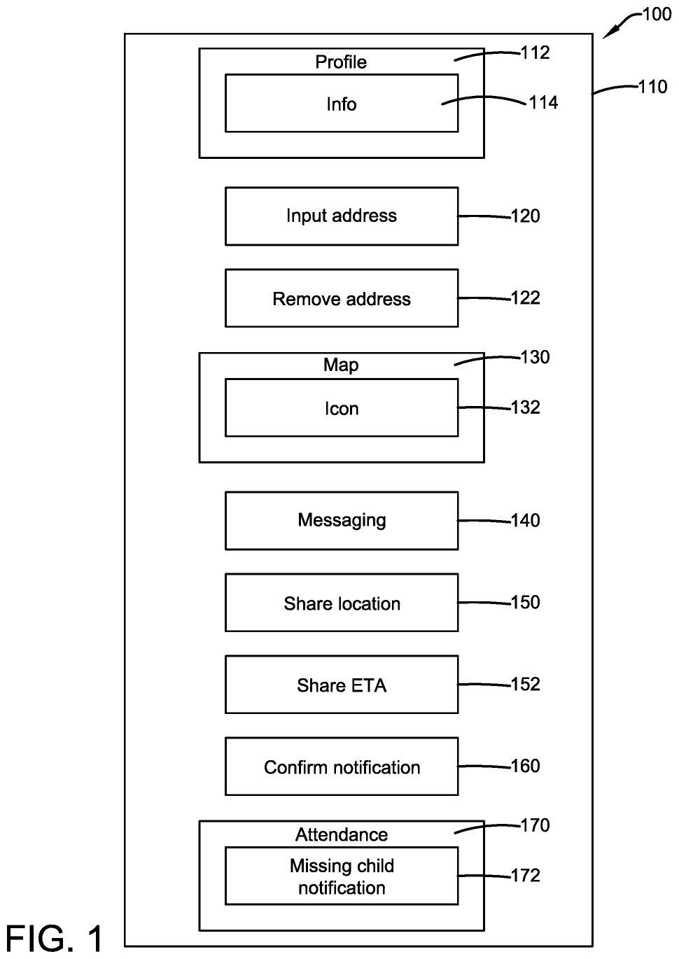

Referring initially to the drawings, FIG. 1 illustrates a graphical view of one potential embodiment of a bus route mobile application 100 of the present invention in accordance with the disclosed architecture. The application 100 is comprised of a mobile application that can be used in order to generate and share bus routes. In the preferred embodiment, the bus route includes a school bus route for pickup and/or dropping off children. The application 100 may be used on any smart device such as, but not limited to, a computer, a tablet, a cell phone, etc. In the preferred embodiment, the application 100 is used on a tablet within a school bus such that it can be seen by the driver (or other bus).

The application 100 has a plurality of features 110. A first feature allows a bus driver (or other administrative user of the application 10 such as, but not limited to, a parent, a legal guardian, a school administrator, etc.) to input at least one pickup/drop-off address 120. This address will be displayed via at least one icon 132 on a geographical map interface 130 on the application 100 that will be visible to a bus driver while using the application 100 on a smart device during a bus route. The application 100 automatically creates the fastest route based on each address inputted.

At least one profile 112 can be created for each bus passenger (i.e., child), wherein the profile 112 may have information 114 such as, but not limited to, at least one pickup address and at least one drop-off address. The pickup and drop-off addresses can be configured within the profile 112 to switch automatically based on week, day, time, etc. In this manner, a child passenger can be picked up at a first parent's address and dropped off at a second parent's address depending on the week/day/time. Other profiles 112 may allow the passenger to be picked up and dropped off at the same address on the same or different days, weeks, times, etc. The profile 112 may also have other information 114 that can be accessed by a bus driver using the application 100. Said information 114 may include, but is not limited to, medical information, behavior notes, parent contact information, etc., regarding a child passenger that the profile 112 has been created for.

The profile 112 may also allow a user such as, but not limited to, a parent to input notes or instructions that are relayed to the bus driver (or other administrative user) once the pickup or drop-off address of the passenger has been reached. This allows an administrative user such as, but not limited to, a parent to note that a child passenger should/should not be dropped off if certain environmental factors are present at the pickup or drop-off address.

A messaging feature 140 of the application 100 allows a user such as, but not limited to, a parent to notify an administrative user and/or bus driver that a child passenger will not be picked up or dropped off on a specific day, time, week, etc. As a result, the application 100 may automatically remove the passenger's pickup and/or drop-off address 122 from the map 130 when a route is generated for that day. This prevents a bus driver from stopping at a pickup/drop-off address that is not needed on that day. The messaging feature 140 may also be used to instruct the bus driver to relay a message to the child from the parent in the event that the child does not possess a smartphone or other similar communication device.

Once all addresses for a route have been inputted and the bus begins driving, the real-time location and route of the bus can be shared 150 manually or automatically to users of the application 100 such as, but not limited to, parents. This allows parents to track the location of the bus and ensure they are home to send or receive children passengers onto/from the bus. In addition, the application 100 may provide each user with an estimated time of arrival 152 for the bus to the address inputted 120. This allows a parent or other caregiver to know precisely when the bus will arrive to pick up or drop-off a child passenger.

In one embodiment, application 100 sends a confirmation notification 160 to users. The notification 160 will be sent in the form of an application 100 notification, text, email, phone call, etc., to confirm to each user (ex. each parent) of a profile 112 that a child has been picked up and/or dropped off by the bus.

The application 100 may also allow a bus driver to take attendance 170 of each child passenger when the child boards the bus to be dropped off. This ensures that each child leaves school on the bus each day. If the child has been recorded as absent using the attendance 170 feature, an automatic missing child notification 172 may be sent in the form of an application 100 notification, text, email, phone call, etc., to confirm to each user (ex. each parent) of a profile 112.

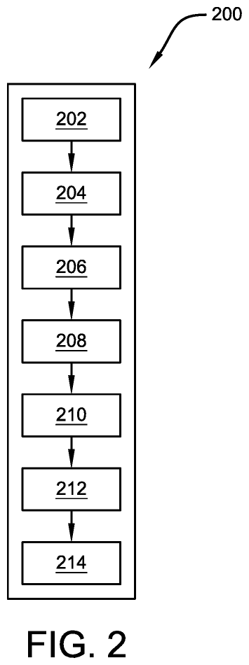

The present invention is also comprised of a method of using 200 the application 100, as seen in FIG. 2. First, an application 100 is provided that generates a bus route, the application 100 comprised of a plurality of features 110 including a profile 112, a map 130, a messaging feature 140, an input address feature 120, and a remove address feature 122 [Step 202]. Then, a user such as, but not limited to, a parent can create a profile 112 for a child passenger, wherein the profile 112 includes information such as, but not limited to, pick-up addresses, drop-off addresses, medical information, contact information, pickup, and drop-off address schedules, etc. [Step 204]. A bus driver may also use the application 100 to take attendance 170 of each child passenger prior to departing for drop-off [Step 206]. Then, a bus driver opens the application 100 on a smart device, such as, but not limited to, a tablet, and begins driving on a pickup and/or drop-off route automatically created by the application 100 [Step 208]. The bus driver observes at least one icon 132 on the map 130 which represents at least one pickup and/or drop-off address for a child passenger [Step 210]. The bus driver and/or the application 100 itself may also manually/automatically share the location 150 of the bus as well as send an ETA 152 for each pickup and/or drop-off point on the route [Step 212]. Once a child has been picked up or dropped off, the bus driver (or the application itself) may manually/automatically send a confirmation notification 160 of the pickup and/or drop-off to contacts associated with the profile 112 of the child passenger who was picked up or dropped off [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bus route mobile application” and “application” are interchangeable and refer to the bus route mobile application 100 of the present invention.

Notwithstanding the foregoing, the bus route mobile application 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bus route mobile application 100 as shown in the FIGS. are for illustrative purposes only, and that many other sizes and shapes of the bus route mobile application 100 are well within the scope of the present disclosure. Although the dimensions of the bus route mobile application 100 are important design parameters for user convenience, the bus route mobile application 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bus route mobile application comprising:
a mobile application that automatically generates a bus route, the mobile application comprised of:
a map interface;
an input address feature;
a profile;
a messaging feature; and
a share route feature.

2. The bus route mobile application of claim 1, wherein the input address feature allows a user to input a pick-up address or a drop-off address.

3. The bus route mobile application of claim 2, wherein the pick-up address or the drop-off address is displayed on the map interface via an icon.

4. The bus route mobile application of claim 2, wherein the bus route mobile application creates a route based on the pick-up address or the drop-off address.

5. The bus route mobile application of claim 2, wherein a user can input a piece of information relating to the pick-up address of the drop-off address within the profile.

6. The bus route mobile application of claim 5, wherein the piece of information is comprised of information relating to a pick-up instruction or a drop-off instruction.

7. The bus route mobile application of claim 1, wherein the share route feature automatically shares the bus route to a user of the bus route mobile application once the bus route has been generated by the bus route mobile application.

8. A bus route mobile application comprising:
a mobile application that automatically generates a bus route, the mobile application comprised of:
an input address feature;
a map interface;
a profile;
a messaging feature;
a share route feature;
a confirmation notification feature; and
an attendance feature.

9. The bus route mobile application of claim 8, wherein the input address feature allows a user to input a pick-up address or a drop-off address.

10. The bus route mobile application of claim 9, wherein the pick-up address or the drop-off address is displayed on the map interface via an icon.

11. The bus route mobile application of claim 9, wherein the bus route mobile application creates a route based on the pick-up address or the drop-off address.

12. The bus route mobile application of claim 9, wherein a user can input a piece of information relating to the pick-up address of the drop-off address within the profile.

13. The bus route mobile application of claim 12, wherein the piece of information is comprised of information relating to a pick-up instruction or a drop-off instruction.

14. The bus route mobile application of claim 8, wherein the share route feature automatically shares the bus route to a user of the bus route mobile application once the bus route has been generated by the bus route mobile application.

15. The bus route mobile application of claim 8, wherein the confirmation notification feature sends a notification to a user of the bus route mobile application when a rider of the bus has been picked up or dropped off.

16. The bus route mobile application of claim 8, wherein if a rider of the bus is not marked as in attendance on the bus via the attendance feature, the bus route mobile application automatically sends a notification to a user of the bus route mobile application.

17. The bus route mobile application of claim 8, wherein the bus route mobile application is comprised of a share ETA feature which shares the ETA of a specific rider of the bus at a pick-up or a drop-off address with a user of the bus route mobile application.

18. A method of using a bus route mobile application, the method comprising the following steps:
providing a bus route mobile application that generates a bus route, the bus route mobile application comprised of a profile feature, a map feature, a messaging feature, an input address feature, and a remove address feature;
creating a profile via the profile feature, wherein the profile is comprised of a pick-up address or a drop-off address; and
driving on a route created by the bus route mobile application in response to the pick-up or drop-off address.

19. The method of using a bus route mobile application of claim 18 further comprised of a step of taking an attendance of a rider of the bus via an attendance feature of the bus route mobile application.

20. The method of using a bus route mobile application of claim 18 further comprised of a step of observing a map icon created by a map interface of the bus route mobile application.
